(19) United States
(12) Patent Application Publication
(10) Pub. No.: US 2023/0042483 A1
(43) Pub. Date: Feb. 9, 2023

(54) Systems and Methods for Compensating for Steering System Failure

(71) Applicant: Atlis Motor Vehicles, Inc., Mesa, AZ (US)

(72) Inventor: Mark Hanchett, Mesa, AZ (US)

(73) Assignee: Atlis Motor Vehicles, Inc., Mesa, AZ (US)

(21) Appl. No.: 17/965,837

(22) Filed: Oct. 14, 2022

Related U.S. Application Data
(60) Provisional application No. 63/256,538, filed on Oct. 16, 2021.

(51) Int. Cl. B62D 5/04; B60K 7/00; B60W 30/18; B62D 3/12

(52) U.S. Cl. CPC B62D 5/0457; B60K 7/0007; B62D 5/0421; B60W 30/18145; B62D 3/126; B60K 2007/0046; B60W 2710/08

(57) ABSTRACT

An electric vehicle controls turning of the electric vehicle in accordance with the orientation of the wheels and skid steering to match the path and turning radius as indicated by the steering wheel. A processing circuit detects the position of the steering wheel and determines the direction of the turn and the resulting path and turning radius of the electric vehicle. The processing circuit either measures the orientation of the wheels or captures data regarding the turning radius of the electric vehicle. The processing circuit controls the traction motors of the electric vehicle so that the actual path and turning radius of the electric vehicle matches the path and turning radius indicated by the steering wheel. Further, the processing circuit may further control controls the traction motors to attempted to maintain the speed of the electric vehicle as indicated by the throttle.

### BACKGROUND

Embodiments of the present invention relate a system for controlling the direction of travel of an electric vehicle in the event of failure of the steering system.

The direction of travel of the vehicle is generally controlled (e.g., governed, set by) a steering system, such as a rack and pinion steering system. Electric vehicle drivers may benefit from a system that supplements or replaces the steering system in the event of complete or partial steering system failure.

### SUMMARY

An electric vehicle may employ a steering system to enable the driver to indicate the direction of travel for the vehicle. The driver indicates the direction of travel by positioning a steering wheel. The steering system operates to orient the wheels at an orientation, so the vehicle travels in the direction of travel (e.g., along the path) indicated by the steering wheel. The steering system may include sensors for detecting steering wheel position (e.g., rotation, orientation), the rack position and/or the wheel orientation. In the event of failure of the steering system, the electric vehicle may supplement or replace the operation of the steering system by controlling the traction motors of the electric vehicle to perform skid steering. Skid steering employs differences in the rate (e.g., speed) and/or direction of rotation of the wheels of the electric vehicle to cause the electric vehicle to travel in a particular direction. Skid steering may cooperate with the orientation of the wheels of the electric vehicle to direct the electric vehicle to travel in the direction indicated by the driver via the steering wheel. Skid steering is employed to overcome the defects of the steering system. Skid steering may supplement the direction of the orientation of the wheels to direct the electric vehicle in accordance with the path and turning radius indicated by the steering wheel and not the path and turning radius indicated by the orientation of the wheels.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is an example embodiment of a steering system for setting the direction of travel of a vehicle.

FIG. 2 the diagram of steering wheel orientation over time.

FIG. 3 is a diagram of rack position that corresponds to the steering wheel rotation of FIG. 1.

FIG. 4 is a diagram of forward wheel orientation that corresponds to the steering wheel rotation of FIG. 2 and rack position of FIG. 3.

FIG. 5 is a diagram of a forward orientation of the front wheels and the direction of travel of the electric vehicle.

FIG. 6 is a diagram of a rightward orientation of the front wheels and the direction of travel of the electric vehicle.

FIG. 7 is a diagram of a leftward orientation of the front wheels and the direction of travel of the electric vehicle.

FIG. 8 is a diagram of turning radius that corresponds to the steering wheel rotation of FIG. 2, the rack position of FIG. 3 and the wheel orientation of FIG. 4.

FIG. 9 is a diagram of the path and turning radius of the electric vehicle for various steering wheel rotations, rack positions, and wheel orientations.

FIG. 10 is a block diagram of the electric vehicle with a second embodiment of the steering system in accordance with various aspects of the present disclosure.

FIGS. 11 and 12 are block diagrams of the electric vehicle setting a direction of travel in accordance with various aspects of the present disclosure.

### DETAILED DESCRIPTION

### Overview

Vehicles, including electric vehicles, include a system whereby a user of the vehicle (e.g., driver) provides information to indicate the path and/or direction of travel of the electric vehicle. Generally, the system that the user uses to control the path and/or direction of travel of the electric vehicle is referred to as a steering system. The user operates a steering wheel to control the steering system to set the orientation of the wheels of the electric vehicle. The orientation of the wheels of the electric vehicle controls the path and/or direction of travel of the electric vehicle. The orientation of the wheels further establishes an arc having a turning radius along which the electric vehicle will travel. The electric vehicle moves along the path set by the orientation of the wheels (e.g., wheel turning radius). Generally, the steering system controls the orientation of only the front wheels; however, the rear wheels may also receive information from the steering system to control their orientation.

In a first example embodiment, the steering system 100 is a fly-by-wire steering system. The steering sensor 160 detects movement of the steering wheel 130. The steering sensor 160 detects the orientation (e.g., position, angle) and direction of rotation of the steering wheel 130. The steering sensor 160 sends captured (e.g., detected, measured) data to a processing circuit 140 regarding the orientation of the steering wheel 130. The processing circuit 140 receives the capture data from the steering sensor 160. The processing circuit 140 controls the actuator 170 to rotate the pinion 112 in accordance with the capture data regarding the orientation of the steering wheel 130. As the pinion 112 rotates clockwise (e.g., CW) and counterclockwise (e.g., (CCW), the rack 110 moves leftward and rightward respectively to orient the wheels (e.g., 126, 512) rightward, leftward or forward.

A second example embodiment of a steering system includes the steering system 1070. The processing circuit 140 uses information from the steering sensor 160 to operate the orientation controllers 1040-1046 to position the wheels 512 and 126 and possibly also wheels 1012 and 1022. The orientation controllers 1040-1046 also detect the orientation of their respective wheels 512, 126, 1012 and 1022. The orientation controllers detect the orientation of the respective wheels independent of positioning the wheels. In an example embodiment, the orientation controllers 1040-1046 each include a wheel orientation sensor 192 detect the orientation of the respective wheels.

The electric vehicle includes traction motors (e.g., DSF, PSF, DSR, PSR). The traction motors include electric motors configured (e.g., adapted) to move (e.g., propel) the electric vehicle. The traction motors may drive directly or via a transmission their respective wheels. The rate and/or direction of rotation of the traction motors may be controlled independently of each other. In the event that the steering system 100 or 1070 fails, partially or completely, the processing circuit 140 may control the traction motors to use skid steering to move the electric vehicle along the path that corresponds to the position and rotation of the steering wheel 130. In other words, the processing circuit 140 determines the turning radius of the path indicated by the position of the steering wheel 130. The processing circuit 140 controls the direction of travel of the electric vehicle 500 through a combination of wheel orientation, direction of wheel rotation and rate of wheel rotation. The processing circuit 140 controls the electric motors to so that the electric vehicle 500 moves along the path indicated by the turning radius that corresponds to the orientation of the steering wheel 130 even though the steering system 100 or 1050 has failed either partially or completely.

### Traction Motors

A traction motor is an electric motor. In an example embodiment, electric vehicle 500 includes four traction motors, DSF, PSF, DSR and PSR, one for each wheel of the electric vehicle 500. The traction motors cause the wheels to rotate at a rate and in a direction. The direction includes clockwise (e.g., forward from the perspective of looking on the outward side of the tire) or counterclockwise (e.g., reverse). The processing circuit 140 may control the rate and/or direction of rotation of each traction motor, and therefore of each wheel. The processing circuit 140 may control the rate and/or direction of rotation of each traction motor independent of the other traction motors. In other words, one traction motor may rotate its corresponding wheel at a rate and/or a direction that is different from the rate and/or direction that any other traction motor rotates its corresponding wheel.

In an example embodiment that includes one traction motor for the front wheels 512 and 126 and one traction motor for the rear wheels 1012 and 1022, separate transmissions for each wheel to be used to rotate each wheel independent of the other wheels. In this example embodiment, the processing circuit 140 may control the transmissions to set the rate and direction of rotation of each wheel independent of the other wheels. The term “rotation” as applied to a wheel refer to the rate and direction of rotation. In other words, a wheel rotates at a rate and in a direction. The processing circuit 140 controls the rotation, rate and direction, of the traction motors and thereby the wheels.

### Steering System—First Embodiment

The steering system 100, includes the steering wheel 130, the steering sensor 160, the actuator 170, the pinion 112, the rack 110, the rack sensor 180, tie rods 120, steering knuckles 122, wheel spindles 124, wheels 126 and 512, wheel orientation sensor 190, processing circuit 140 and memory 142. The steering system 100 orients only the front wheels (e.g., 126, 512).

The driver uses the steering wheel 130 to indicate the desired direction of travel of the electric vehicle. The direction of travel indicated by the steering wheel 130 also sets the turning radius made by the electric vehicle 500. Travel in a straight line may be considered as having a turning radius of zero.

The steering sensor 160 detects the movement (e.g., rotations) of the steering wheel 130. The steering sensor 160 captures data regarding the position of the steering wheel 130, the rotation of the steering wheel 130 and the rate of rotation of the steering wheel 130. The steering sensor 160 provides the captured (e.g., detected, measured) data to the processing circuit 140. The processing circuit 140 receives the data from the steering sensor 160. The processing circuit 140 interprets the data to determine the orientation, the rotation, the rate of rotation of the steering wheel 130.

The steering wheel 130 may have limits of rotation. For example, the steering wheel 130 may be capable of rotating from a central position a full rotation (e.g., 360 degrees) in the clockwise direction and a full rotation in the counterclockwise direction. When the steering wheel 130 reaches the limit of rotation, the steering wheel 130 may cease to rotate. The steering sensor 160 may detect when the steering wheel 130 is positioned in the central position, a counterclockwise limit, a clockwise limit and/or any position in between.

The processing circuit 140 controls the operation of the actuator 170. Responsive to data from the steering sensor 160, the processing circuit 140 operates the actuator 170 to turn the pinion 112. As the steering wheel 130 rotates in the clockwise direction, from the perspective of the driver facing the steering wheel 130, the processing circuit 140 controls the pinion 112 to rotate in the clockwise direction. As the steering wheel 130 rotates in the counterclockwise direction, the processing circuit 140 controls the pinion 112, using actuator 170, to rotate in the counterclockwise direction. The processing circuit 140 is configured to control the operation of the actuator 170 so that the rotation and rate of rotation of the pinion 112 corresponds to the rotation and rate of rotation of the steering wheel 130 or to a ratio thereof.

The gears of the pinion 112 mesh with the gears of the rack 110. As the pinion 112 rotates in the clockwise direction, from the perspective of the driver facing the steering wheel 130, the gears of the pinion 112 move the rack 110 in the leftward direction, so that the CW end 116 moves toward the pinion 112. When the CW end 116 reaches the pinion 112, the pinion 112 can no longer move the rack 110 in the leftward direction. In other words, the rack has reached the limit of its movement in the leftward direction. The limit of rotation of the steering wheel 130 in the clockwise direction may correspond with the limit of leftward movement of the rack 110.

As the pinion 112 rotates in the counterclockwise direction, from the perspective of the driver, the gears of the pinion 112 move the rack 110 in the rightward direction, so that the CCW end 114 moves toward the pinion 112. When the CCW end 114 reaches the pinion 112, the pinion 112 can no longer move the rack 110 in the rightward direction because the rack has reached the limit of its movement in the rightward direction. The limit of rotation of the steering wheel 130 in the counterclockwise direction may correspond with the limit of rightward movement of the rack 110.

The rack sensor 180 detects the movement of the rack 110. The rack sensor 180 is in a fixed position with respect to the pinion 112. As the rack 110 moves to the right or to the left, the rack sensor 180 detects its rightward or leftward movement respectively. The rack sensor 180 also detects the position of the rack 110 with respect to the pinion 112, so the rack sensor 180 may determine when the CW end or the CCW end has move to be positioned near pinion 112 or any position in between. The rack sensor 180 may detect the rate of movement of the rack 110.

The rack sensor 180 may report its captured data to the processing circuit 140. The processing circuit 140 is configured to use the data from the rack sensor 180 to determine the position, direction of movement, and/or rate of movement of the rack 110. The processing circuit 140 is configured to further correlate the position of the rack 110 to the position of the steering wheel 130. The processing circuit 140 is configured to correlate the direction and/or rate of rotation of the steering wheel 130 to the direction and/or rate of movement of the rack 110. The processing circuit 140 is configured to correlate the limits of the movement of the rack 110 to the limits of the rotations of steering wheel 130. The processing circuit 140 is configured to correlate the central position of the steering wheel 130 to a central position of the rack 110. The processing circuit 140 is configured to correlate the position of the rack 110 to the orientation of the wheels.

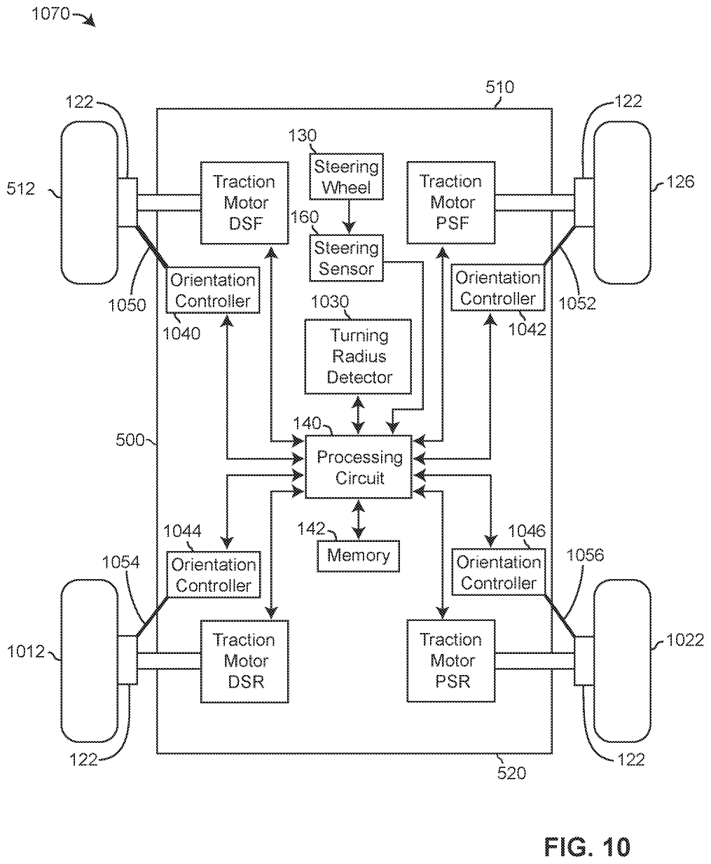

The rack 110 is connected to the tie rods 120. The rack 110 moves the tie rods 120 to orient the front wheels 126 and 512. While the rack 110 is positioned in its central position, the front wheels 126 and 512 are oriented in a forward position. In other words, the wheels 126 and 512 are oriented straight forward, as best shown in FIGS. 5 and 10, so that the electric vehicle travels in a straight course (e.g., zero turning radius). While the rack 110 is positioned in the leftmost position, the wheels 126 and 512 are oriented in their rightward orientation, as best seen in FIG. 6, so that the electric vehicle will make a right-hand turn (e.g., rightward turning radius). While the rack 110 is positioned in the rightmost position, the wheels 126 and 512 are oriented in the leftward orientation, as best seen in FIG. 7, so that the electric vehicle will make a left-hand turn (e.g., leftward turning radius). The angle of orientation of the wheels 126 and 512 determine the turning radius of the path the electric vehicle will travel.

### Steering System—Second Embodiment

The steering system 1070 includes the steering wheel 130, the steering sensor 160, orientation controllers 1040-1046, steering knuckles 122, wheel spindles (not shown), wheels 126, 512, 1012 and 1022, processing circuit 140 and memory 142.

As with the first embodiment, the driver uses the steering wheel 130 to indicate the desired direction of travel, which also sets the turning radius of the electric vehicle. The steering sensor 160 captures data regarding the position of the steering wheel 130 as discussed above. The steering sensor 160 provides its captured data to the processing circuit 140, which determines the orientation of the steering wheel 130.

The processing circuit 140 controls the operation of the orientation controllers 1040, 1042, 1044 and 1046, which in turn control the orientation of the wheels 512, 126, 1012 and 1022 respectively. In one embodiment of the electric vehicle 500, orientation controllers 1044 and 1046 are omitted so that only the front wheels 512 and 126 are controlled by the steering system 1070. The steering system 1070 controls the orientation of all four wheels 512, 126, 1012 and 1022.

Responsive to data from the steering sensor 160, the processing circuit 140 is configured to operate the orientation controllers 1040 and 1042 to orient the wheels 512 and 126 respectively. As the steering wheel 130 rotates in the clockwise direction, from the perspective of the driver facing the steering wheel 130, the processing circuit 140 is configured to control the orientation controllers 1040 and 1042 to orient the wheels 512 and 126 respectively at a rightward angle (e.g., angle 212). As the steering wheel 130 rotates in the counterclockwise direction, from the perspective of the driver facing the steering wheel 130, the processing circuit 140 is configured to control the orientation controllers 1040 and 1042 to orient the wheels 512 and 126 respectively at a leftward orientation (e.g., angle indicated by line 452).

The processing circuit 140 may be further configured to control the orientation controllers 1044 and 1046 responsive to the data from steering sensor 160 to accomplish four-wheel steering. The rightward and leftward angles of the wheels 1012 and 1022 may be a fraction (e.g., 10%-25%) of the rightward and leftward angles of the wheels 512 and 126. At low speeds (e.g., less than 20 mph), the wheels 512 and 126 may turn at a rightward or leftward angle responsive to the steering sensor while the wheels 1012 and 1022 or oriented at a corresponding leftward or rightward angle respectively. Orienting the rear wheels 1012 and 1022 at an angle opposite the front wheels 512 and 126 decreases the turning radius of the electric vehicle 500. At low speeds, while in a special mode such as a parking mode, the wheels 512, 126, 1012 and 1022 may be set to a rightward or a leftward angle and the angle for the front wheels and the back wheels may be the same (e.g., equal). The direction and similarity of the angles of the front and back wheels permits the electric vehicle 500 to move at an angle to more easily enter or exit a parking space. At high speeds (e.g., more than 20 mph), the front wheels 512 and 126 are oriented in the same direction (e.g., rightward, leftward) as the rear wheels 1012 and 1022, which improves control during lane changes.

Either the steering system 100 or the steering system 1070 may be used to control the orientation of the front wheels 512 and 126. The steering system 1070 may be used to control the orientation of all four wheels 512, 126, 1012 and 1022.

### Steering Wheel Rotation

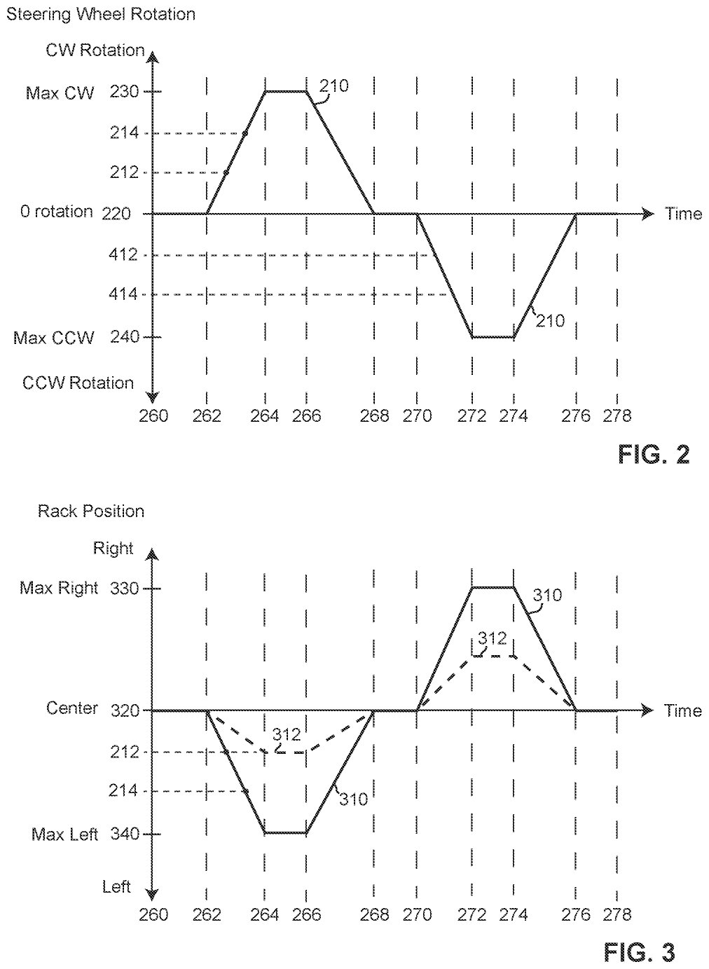

The graphs of FIGS. 2-4 illustrate the position and rotation of the steering wheel 130, the position and movement of the rack 110, and the orientation of wheels 126 (e.g., 512, 1010, 1020). The graphs of FIGS. 2-4 correspond to either the steering system 100 or the steering system 1070 of the steering system. The x-axis of the graphs identifies a point in time. The point in time (e.g., 260, 262, 264, 266, 268, 270, 272, 274, 276, 278) labeled in one graph corresponds to the same labeled time in the other graphs. The direction of rotation of the steering wheel 130, movement of the rack 110 and orientation of the wheels 126 is described from the perspective of the driver while facing the steering wheel 130.

The steering sensor 160 captures the position, the direction of rotation and the rate of rotation of the steering wheel 130. The data captured by the steering sensor 160 is shown in the graph steering wheel rotation of FIG. 2. The position of the line 210 above the x-axis represents a rightward orientation of the steering wheel 130 while the position the line 210 below the x-axis represents a leftward orientation. The slope of the line 210 represents the rate of rotation of the steering wheel. Between the time 260 and the time 262, the steering wheel 130 is positioned with no rotation either clockwise or counterclockwise. At time 262, the steering wheel 130 begins to rotate in the clockwise direction. The range of rotation in the clockwise direction is from zero rotation 220 to the max CW rotation 230. The points 212 and 214 represent orientations of the steering wheel 130 between zero rotation 220 and the max CW rotation 230. At point 212, the steering wheel 130 is rotated less in the clockwise direction than at the point 214. The steering wheel 130 reaches its maximum clockwise orientation (e.g., max CW rotation 230) at time 264 and remains at its maximum clockwise orientation until the time 266 under this steering example.

At the time 266, the steering wheel 130 begins to rotate in the counterclockwise direction from the maximum clockwise position, the max CW rotation 230, until it reaches zero rotation 220 at time 268. Between time 268 and time 270, the steering wheel 130 remains at zero rotation 220. At time 270, the steering wheel 130 resumes its counterclockwise rotation until at time 272, the steering wheel has rotated to its maximum counterclockwise position (e.g., max CCW position 240). The steering wheel 130 remains at the max CCW position 240 until time 274. At time 274, the steering wheel 130 begins to rotate in the clockwise direction until it reaches zero rotation 220 at the time 276. The steering wheel 130 remains at the zero rotation 220 orientation thereafter.

### Rack Movement

The rack sensor 180 captures the position, the direction of movement and the rate of movement of the rack 110. In an example embodiment, the rack 110 moves while the rack sensor 180 remains stationary to detect the movement and position of the rack 110. The data captured by the rack sensor 180 is shown in the graph rack position of FIG. 3. The line 310 identifies the position, direction of movement, and the rate of movement of the rack 110 with respect to time. The times indicated with respect to the rack position in FIG. 3 correspond to the times identified in FIG. 2, so the orientation of the steering wheel 130 at each time corresponds to a position of the rack 110 at the same corresponding time.

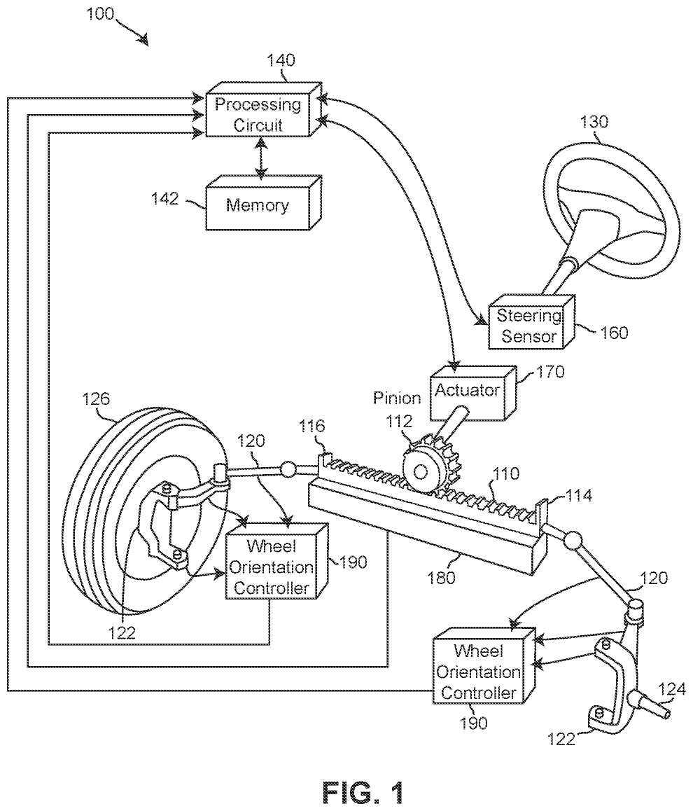

Between the time 260 and the time 262, the steering wheel is oriented with no rotation either clockwise or counterclockwise, so the pinion 112 is positioned at the center position 320 of the rack 110. At the time 262, the steering wheel 130 begins to rotate in the clockwise direction, so the pinion 112 also begins to rotate in the clockwise direction. Responsive to the clockwise rotation of the pinion 112, the rack 110 begins to move in the leftward direction with respect to the rack sensor 180 and from the perspective of the driver, so that the CW end 116 of the rack 110 approaches the pinion 112. The rotation of the pinion 112 is controlled by actuator 170, which in turn is controlled by the processing circuit 140. The rate of rotation of the pinion 112 likely is not the same rate of rotation as the steering wheel 130. In fact, in the example embodiment shown in FIG. 1, the rate of rotation of the pinion 112 is higher than the rate of rotation of the steering wheel, but proportional so that as the steering wheel 130 turns from zero rotation 220 to the max CW rotation 230 or the max CCW position 240, the pinion reaches the CW end 116 or the CCW end 114 respectively.

When the steering wheel 130 is positioned at the point 212, the rack 110 is positioned about a third of the way between the center of the rack 110 and the CW end 116. As the steering wheel 130 and the pinion 112 continue to turn in the clockwise direction, the rack 110 continues to move leftward. When the steering wheel 130 is positioned at the point 214, the rack 110 is positioned about two thirds of the way between the center of the rack 110 and the CW end 116. As the steering wheel and the pinion 112 continue to turn in the clockwise direction, the rack 110 continues to move leftward until at time 264 the CW end 116 of the rack 110 reaches the pinion 112. When the CW end 116 reaches the pinion 112, the steering wheel 130 is positioned at its maximum clockwise position and the rack 110 is positioned at its maximum leftward position which is max left position 340.

Between the time 264 and the time 266, the steering wheel 130 remains at its maximum clockwise position, the max CW rotation 230, so the rack 110 remains at its max left position 340. From the time 266 until the time 268, the steering wheel 130 rotates in the counterclockwise direction from the maximum clockwise position, the max CW rotation 230, until it reaches zero rotation 220. As the steering wheel 130 rotates in the counterclockwise direction, the pinion 112 also rotates in the counterclockwise direction, so the rack 110 moves in the rightward direction. When the steering wheel 130 reaches the zero rotation 220 position, the rack has reached the center position 320, so that the pinion 112 is positioned at the center of the rack 110. Since the steering wheel remains in the zero rotation 220 position from the time 268 to the time 270, the rack 110 remains at the center position 320 position during that time.

At the time 270, the steering wheel 130 resumes its counterclockwise rotation, so the pinion 112 also resumes its counterclockwise rotation. As the pinion 112 rotates in the counterclockwise direction, the rack 110 moves rightward from its center position 320 until the CCW end 114 of the rack 110 reaches the pinion 112 at the time 272. From the time 272 until the time 740, the steering wheel 130 remains at its maximum counterclockwise position, the max CCW position 240, so the CCW end 114 of the rack 110 remains positioned next to the pinion 112. At the time 274, the steering wheel 130, and therefore the pinion 112, begin to rotate in the clockwise direction until the steering wheel reaches its position of zero rotation 220. As the steering wheel 130 and the pinion 112 rotate in the clockwise direction, the rack 110 moves in the leftward direction so that the CCW end 114 moves away from the pinion 112. When the steering wheel 130 reaches zero rotation 220 position, the rack 110 is positioned so the pinion 112 is at the center of the rack 110.

The processing circuit 140 receives data from the steering sensor 160 and drives the actuator 170 to rotate the pinion 112 so that the positions of the steering wheel 130 correspond to the appropriate positions of the rack 110 as discussed above. The rack sensor 180 reports its data to the processing circuit 140, so the processing circuit 140 may monitor the position, direction of rotation, and rate of rotation of the rack 110 with respect to the position and movement of the steering wheel 130. During normal operation, the position and rotation of the steering wheel 130 as indicated by the line 210 corresponds to the position and movement of the rack 110 as indicated by the line 310.

### Wheel Orientation and Turning Radius

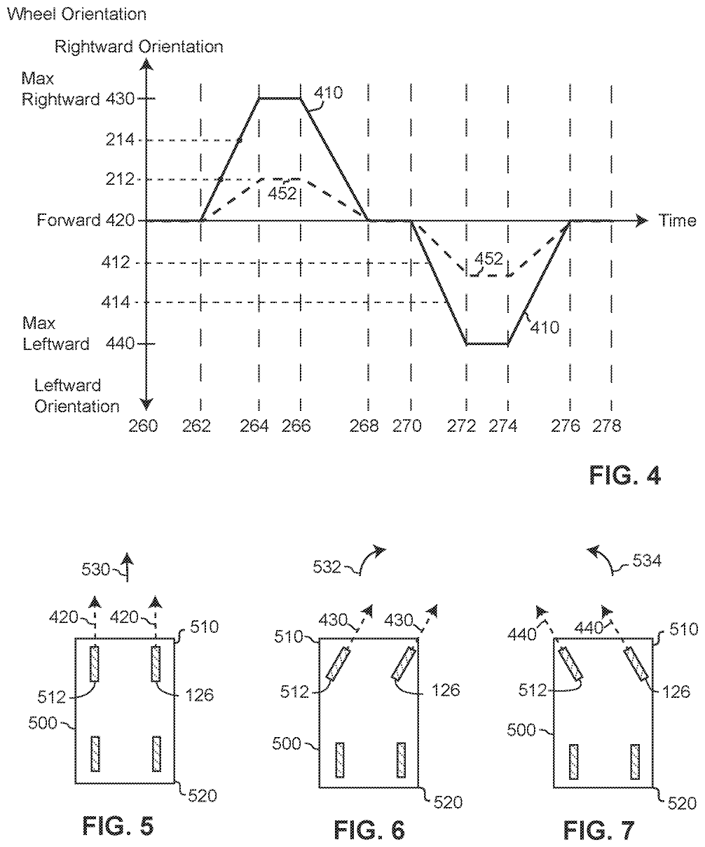

The wheel orientation sensors 190 (one wheel orientation sensor 190 per wheel) or the orientation controllers (e.g., 1040-1046) detects the orientation of the wheels 126 and 512, and wheels 1012 and 1022. The data captured by the wheel orientation sensor 190 or the orientation controller is shown in the graph wheel orientation of FIG. 4. The line 410 identifies the orientation of the front wheel 512 or 126.

A graph similar to FIG. 4 could show the orientation of the rear wheels 1012 and 1022; however, at low speeds, the angle of the rear wheels 1012 and 1022 would be opposite the angle of the front wheels 512 and 126. At high speeds, the angle (e.g., rightward, leftward) of the rear wheels 1012 and 1022 would be the same as the angle of the front wheels 512 and 126. At low speeds and at high speeds, the amount of the angle of the rear wheels 1012 and 1022 would be less than the amount of the angle of the front wheels 512 and 126. In the special mode (e.g., parking), the angle and possibly the amount of the angle of the rear wheels 1012 and 1022 would be the same as the angle and the amount of the angle of the front wheels 512 and 126. The times of the various orientations of the front wheels 512 and 126 shown in FIG. 4 aligned with the times shown in FIGS. 2 and 3.

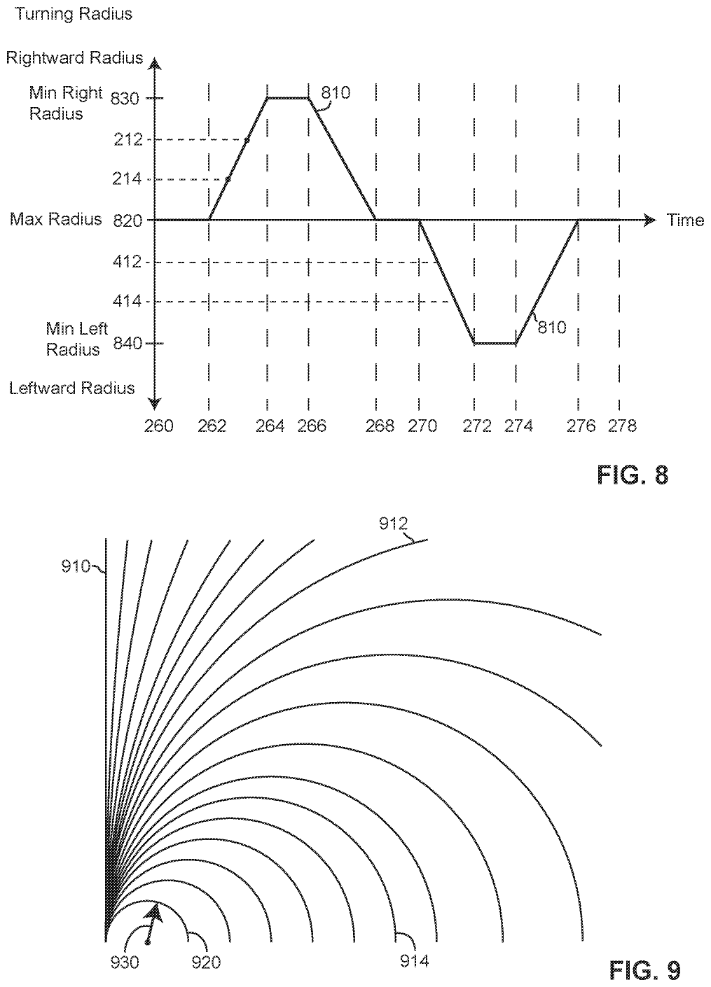

Example orientations of the wheels 512 and 126 are shown in FIGS. 5-7 and correlate to the wheel orientations 420, 430 and 440 respectively of FIG. 4. The line 810 of FIG. 8 shows the turning radius of the electric vehicle 500. Under normal operation, the line 810 corresponds to the lines to 210, 310 and 410 at the times specified. When the steering system 100 or 1070 is working properly, the turning radius 810 corresponds to the line 410 for wheel orientation and the line 210 for steering wheel rotation. When the steering system 100 or 1070 is not functioning properly, the line 810 corresponds to the line 210 and the desired turning radius as determined by the processing circuit 140 using the data provided by the steering sensor 160 and line 810.

Under normal operation, while the wheels 512 and 126 are oriented in the forward orientation 420 (see FIG. 5), the turning radius 810 is at its maximum radius, max radius 820. While the wheels 512 and 126 are oriented at their max rightward orientation 430 (see FIG. 6), the turning radius of the electric vehicle 500 is the minimum right radius, the min right radius 830. While the wheels 512 and 126 are oriented at their max leftward orientation 440 (see FIG. 7), the turning radius of the electric vehicle 500 is the minimum left radius, min left radius 840.

Between the time 260 and the time 262, the wheels are oriented in the forward orientation 420 and the steering wheel 130 is oriented at 0 (i.e., zero) rotation 220. The forward orientation of the wheels 512 is shown in FIG. 5. In the forward orientation, the wheels 512 are oriented in a forward position that causes the electric vehicle 500 to travel in the direction 530 which is in a straight line. While the wheels 512 and 126 are positioned in the forward orientation 420, the turning radius of the electric vehicle 500 is at its maximum (e.g., near infinite), so the turning radius between the time 260 and the time 262 is the max radius 820 which also corresponds to the path and turning radius shown by the line 910 in FIG. 9.

At the time 262, the wheels 512 and 126 began to turn from the forward orientation 420 to a rightward orientation. When the wheels 512 and 126 reach the point 212, the steering wheel 130 is rotated to its corresponding rotation at the point 212, and the turning radius corresponds to the turning radius at the point 212. The line 912 in FIG. 9 represents the path and turning radius of the electric vehicle 500 at the point 212. While the steering wheel 130 is positioned at its point 214, the wheels 512 and 126 are oriented at their point 214. The turning radius at the point 214 is less (e.g., tighter turn) than the turning radius at the point 212 and corresponds to the path and turning radius shown by the line 914 in FIG. 9.

The max rightward orientation of the wheels 512 and 126 is shown in FIG. 6. The maximum rightward orientation of the wheels 512 and 126 cause the electric vehicle 500 to travel in a rightward direction 532. Because the wheels 512 and 126 are at their maximum rightward orientation, the electric vehicle will turn with the min right radius 830. The line 920 of FIG. 9 represents the path and turning radius of the minimum rightward turning radius of the electric vehicle 500. The radius of the minimum turning radius is identified by the line 930. The wheel orientation 410 remains at its max rightward orientation 430 from the time 264 until the time 266. During the same time, the turning radius remains at the min right radius 830.

From the time 266 until the time 268, the wheel orientation 410 changes from the max rightward orientation 430 to the forward orientation 420. The turning radius 810 changes from the min right radius 830 to the max radius 820. Graphically, the turning radius changes from the turning radius 920 through the various radii until it reaches the turning radius 910, as shown in FIG. 9. From the time 268 until the time 270, the wheels 512 and 126 remain oriented in the forward 420 orientation. Meanwhile, the turning radius 810 remains at the max radius 820.

From the time 270 to the time 272, the wheels 512 and 126 move from the forward orientation 420 to the max leftward orientation 440. When the wheels 512 and 126 reach the point 412, the steering wheel 130 is rotated to its corresponding rotation at the point 412 in FIG. 2, and the turning radius corresponds to the turning radius at the point 412 on FIG. 8. The line 912 in FIG. 9 represents the path and turning radius of the electric vehicle 500 at the point 412, but in the leftward direction. While the steering wheel 130 is positioned at its point 414, the wheels 512 and 126 are oriented at their point 414. The turning radius at the point 414 is less (e.g., tighter turn) than the turning radius at the point 412 and corresponds to the path and turning radius shown by the line 914 in FIG. 9, but in the leftward direction.

As the turning radius 810 goes from the max radius 820 to the min left radius 840, the turning radius changes from the turning radius 910 to the turning radius 920, but in the leftward direction. From the time 272 to the time 274, the wheels 512 and 126 are oriented in the max leftward orientation 440, which is shown in FIG. 7. The max leftward orientation 440 causes the electric vehicle 500 to travel in the leftward direction 534. While the wheels 512 are oriented at the max leftward orientation 440, the turning radius of the electric vehicle 500 is the min left radius 840 and corresponds to the path and turning radius shown by the line 920 in FIG. 9, but in the leftward direction.

Starting at the time 274, the wheels 512 and 126 move from the max leftward orientation 440 to the forward orientation 420. As the orientation of the wheels 512 and 126 change from the max leftward orientation 440 to the forward orientation 420, the turning radius of the electric vehicle 500 changes from the min left radius 840 to the max radius 820, which may be seen as changing from the path and turning radius of the line 920 with the radius 930 to the straight line 910, but from the leftward direction.

### Orientation Controller Movement

A graph of the movement of the arms 1050-1056 of the orientation controllers 1040-1046 respectively is not provided. As discussed above, the processing circuit 140 is configured to receive data from the steering sensor 160 regarding the position and movement of the steering wheel 130. The processing circuit 140 is configured to translate the data into wheel orientations, for example the wheel orientations shown in FIG. 4 by the line 410. The processing circuit 140 is configured to control the extension and retraction of the arms 1050-1056 to orient the wheels 512, 126, 1012 and 1022 respectively in accordance with the data from the steering sensor 160.

The processing circuit 140 is configured to control the arms 1050-1056 independent of each other. During normal operation of the steering systems 100 and 1070, the orientation controller 1040 is configured to extend and retract arm 1050 while orientation controller 1042 is configured to retract and extend arm 1052 respectively to orient the wheels 512 and 126 in the forward, leftward and rightward directions at the same time. The processing circuit is adapted control the arms 1054 and 1056 to orient the wheels 1012 and 1022 respectively as discussed above for low speeds, high speeds and special modes. In the example embodiment of FIG. 10, to orient the front wheels 512 and 126, or the rear wheels 1012 and 1022, in the same direction (e.g., leftward, rightward, forward), one arm, 1050 or 1052 and 1054 or 1056, will need to retract while the other arm, 1052 or 1050 and 1056 or 1054, extends.

### Congratulations

### In the Event of Failure of the Steering System

It is desirable that when the steering system 100 or 1070 fails, that the electric vehicle 500 still be able to be steered in the direction and along the path desired by the driver. Failure of the steering sensor 160 would be catastrophic and may result in causing the electric vehicle 500 to be non-operational. The failure of the steering sensor 160 means that the driver cannot provide information as to the desired direction of travel to the processing circuit 140. Since the driver knows the desired course, failure of the steering sensor 160, in whole or in part, means that the driver cannot provide information as to where the electric vehicle should go. Unless the electric vehicle 500 is on a preprogrammed course so that the processing circuit 140 has information regarding the destination and the course of travel, failure of the steering sensor 160 means that the electric vehicle 500 cannot be controlled to travel toward the destination along desired route indicated by the driver.

As long as the driver can indicate the direction of travel, via the steering wheel 130 and the steering sensor 160, the failure of other portions of the steering systems 100 or 1070 may be overcome using the traction motors (e.g., DFS, PSF, DSR, PSR). For example, in the event of complete or partial failure of the actuator 170, the pinion 112, the rack 110, the tie rods 120, the wheels spindles 124, and/or one or more orientation controllers 1040-1046, the processing circuit 140 is configured to use information from the steering sensor 160 and the wheel orientation sensors (e.g., 190, 1040-1046) to detect the orientation of the front wheels 512 and 126, and possibly the back wheels 1012 and 1022 in the case of four-wheel steering, to control the traction motors to skid steer in the direction indicated by the driver via the steering wheel 130. The processing circuit 140 is configured to control the traction motors to drive the electric vehicle 500 in the direction indicated by the steering wheel 130 (e.g., line 210) with the turning radius (e.g., line 810, FIG. 9) corresponding to the position of the steering wheel 130.

For example, with respect to the steering system 100 of the steering system, assume that the actuator 170, the pinion 112, the rack 110 and/or the tie rods 120 fail. Further assume that the rotation of the steering wheel 130 conforms to the line 210 while the rack position and the wheel orientation conform to the lines 312 and 452 respectively. In this failure mode, while the steering wheel 130 is positioned at its maximum clockwise rotation, the max CW rotation 230 (e.g., time 264 to time 266), the rack position 312 and the wheel orientation indicated by the line 452 are not the max left position 340 and the max rightward orientation 430 respectively as during normal operation. Even though the driver indicates through the steering wheel 130 that the electric vehicle 500 should make a sharp right-hand turn, the rack 110 is not positioned and the wheels are not oriented to make the sharp right-hand turn.

In this situation, the wheel orientation sensors 190 can measure the orientation of the wheels 512 and 126. The wheels 512 and 126 are not oriented to the maximum rightward orientation, so the wheel orientation sensor 190 detects a wheel orientation as being somewhere between the forward 420 orientation and the max rightward orientation 430, in this example at orientation 212 as shown in FIG. 4. Having information regarding the actual orientation of the wheels 512 and 126 enables the processing circuit 140 to determine the direction and wheel turning radius of the electric vehicle 500 based on the wheel orientation alone. The processing circuit 140 is also configured to determine the desired direction of travel and the turning radius as indicated by the steering wheel 130. The processing circuit 140 is configured to detecting a difference between the desired turning radius indicated by the steering wheel 130 and the wheel turning radius that will be traveled by the electric vehicle 500 based on the orientation of the wheels 512 and 126.

The processing circuit 140 may compare the difference between the desired turning radius indicated by the steering wheel 130 and the wheel turning radius based on the orientation of the wheels 512 and 126 to a threshold (e.g., error threshold). The threshold for determining that the wheel turning radius is not the same as the desired turning radius is referred to as the error threshold. In an example embodiment, the error threshold is in the range of 11%-50%. If the difference is greater than the error threshold, then the processing circuit 140 knows that the electric vehicle 500 will not travel along the path of the desired turning radius because the wheels 512 and 126 are not oriented to direct the electric vehicle 500 along the desired turning radius. In other words, the electric vehicle 500 will not go where the driver wants it to go. So, if the desired turning radius differs from the wheel turning radius by more than 11%-50%, then the processing circuit 140 concludes that the electric vehicle 500 will not travel along the path indicated by the desired turning radius.

When the processing circuit 140 determines that the difference between the desired turning radius and the wheel turning radius is greater than the error threshold, the processing circuit 140 is configured to take action so that the path actually traveled by the electric vehicle 500 is within a threshold of the desired turning radius. This threshold is referred to as the tracking threshold. To make the turning radius traveled by the electric vehicle 500 be to within the tracking threshold of the desired turning radius, the processing circuit 140 may control the rotation of the traction motors and thereby the wheels to cause the electric vehicle 500 to travel the path indicated by the desired turning radius as opposed to traveling the path indicated by the wheel turning radius. More specifically, the processing circuit may control the rate and direction of rotation of the traction motors, and thereby the wheels, to set the path traveled by the electric vehicle 500.

In other words, the processing circuit 140 may control the rotation of the traction motors to make up the difference, to within the tracking threshold, between the actual path of travel and the path indicated by the desired turning radius. The processing circuit 140 is configured to control the traction motors so that in spite of the inconsistency between the orientation of the wheels 512 and 126 (e.g., wheel turning radius) and the position of the steering wheel 130 (e.g., desired turning radius), the electric vehicle 500 turns (e.g., travels the path, travels the radius) indicated by the position of the steering wheel 130.

In an example embodiment, the tracking threshold is within the range of 0%-10%. In other words, the processing circuit 140 controls the rotation of the traction motors so that the actual radius of the path traveled by the electric vehicle 500 is to within 0%-10% of the desired turning radius. If the processing circuit cannot control the rotation of the traction motors so that the actual turning radius of the electric vehicle 500 is to within an amount in the range of 0%-10%, then the processing circuit 140 may inform the driver that the faults of the steering system cannot be corrected in that immediate service is necessary. The processing circuit 140 may control the traction motors so that the path traveled by the electric vehicle 500 is as close to the desired turning radius as possible to avoid collision while the driver brings the electric vehicle 500 to a stop.

For example, at the time 264, the steering wheel 130 is at the max CW rotation 230. With the steering wheel 130 positioned at the max CW rotation 230, the electric vehicle 500 should be turning at the min rightward radius 930 that will result in the path and turning radius shown by the line 920. However, at the time 264, the point 412 of the wheel orientation is only positioned at orientation 212 to the right. So, based on wheel orientation alone, the turning radius of the electric vehicle 500 would be the path and turning radius for the line 912 as opposed to the line 920. The processing circuit 140 is configured to detect the difference between the position of the steering wheel at max CW rotation 230 and the orientation of wheels 512 and 126 at point 412 of the wheel orientation. The processing circuit 140 is further configured to detect that the difference between the position of the steering wheel, with its associated turning radius, and the orientation of the wheels 512 and 126, with their associated turning radius, is greater than the error threshold. In other words, because of the failure of the steering system 100, the electric vehicle 500 cannot make the sharp right-hand turn indicated by the steering wheel 130. Further, the processes circuit 140 can detect that the failure will inhibit the electric vehicle 500 from traveling the desired direction indicated by the driver via the steering wheel 130.

A failure of the steering system 1070 may also result in a mismatch between the position of the steering wheel 130 and the orientation of the wheels 512 and 126. In this example, the orientation controllers 1040 and 1042 to have failed so that at the time 264, the wheels 512 and 126 are oriented in the rightward direction 212 as opposed to the max rightward orientation 430. Failure of the second embodiment of the steering system 1070 means that the electric vehicle 500 will not follow the direction indicated by the steering wheel 130 because orientation controllers 1040 and 1042 have not positioned the wheels 512 and 126 at the orientation corresponding to the max CW rotation 230. The processing circuit 140 is configured to detect that the failure of the steering system 1070 will result in the electric vehicle 500 not traveling the path indicated by the steering wheel 130.

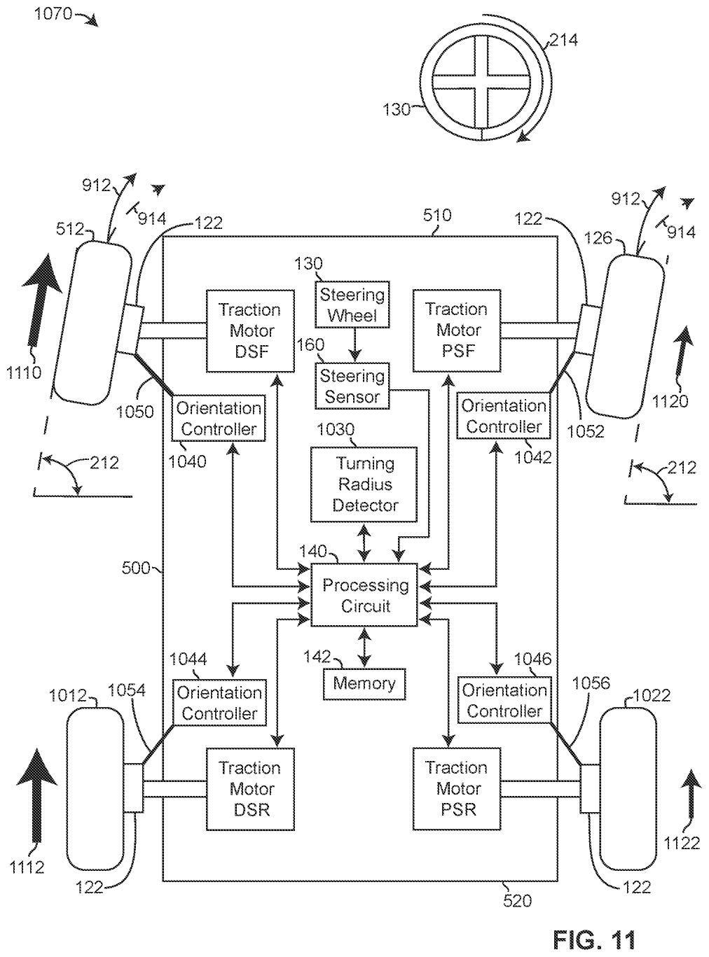

Once processing circuit 140 has determined that the steering system 100 or 1070 can only make a turn with the radius that will take it along the line 912, as opposed to a turn along line 920, the processing circuit 140 operates the traction motors to turn the electric vehicle 500 more to the right along the line 920 which is consistent with the position of the steering wheel 130. To accomplish the rightward turn with the smaller turning radius 930, the processing circuit 140 decreases the rate (e.g., speed) of rotation of the traction motors PSF and PSR, rate of rotation 1120 and 1122 respectively, and increases the rate of rotation of the traction motors DSF and DSR, rate of rotation 1110 and 1120 respectively, as shown in FIG. 11.

The reduced rate of rotation of the wheels 126 and 1022 and the increased rate of rotation of the wheels 512 and 1012 will cause the electric vehicle 500 to skid steer to the right thereby decreasing the turning radius from the radius of the line 912 to the radius of the line 920. In another example embodiment, may be necessary for the processing circuit 140 to operate the wheel 126 and/or 1022 in the reverse direction for a period of time so that the turning radius of the path traveled by the electric vehicle 500 is the same as the desired turning radius indicated by the steering wheel 130.

Regardless of the portion of the steering system 100 or 1070 that fails, the processing circuit 140 detects the discrepancy between the position of the steering wheel 130, with it associated turning radius, and the orientation of the wheels, with their associated turning radius. The processing circuit 140 is configured to receive wheel orientation data from the wheel orientation sensors 190 or the orientation controllers 1040-1046. The processing circuit 140 is further configured to receive data from steering sensor 160 and compare the steering sensor data to the wheel orientation data to identify the discrepancy, in particular the discrepancy (e.g., difference) in the turning radii. The processing circuit 140 is further configured to determine whether the difference in the turning radii is greater than the error threshold. If the difference is greater than the error threshold, the processing circuit 140 is configured to take action to move the electric vehicle 500 along the path indicated by the desired turning radius.

Once the discrepancy is identified, the processing circuit 140 is configured to control the traction motors to perform skid steering to increase or decrease the turning radius of the electric vehicle 500 to match the desired turning radius, within the tracking threshold. So, the processing circuit 140 takes into consideration the orientation of the wheels when determining how to control the traction motors to provide the direction of travel indicated by the desired turning radius.

The processing circuit 140 may control all of the traction motors, DSF, PSF, DSR and PSR to skid steer the electric vehicle in the direction indicated by the steering wheel 130. The front wheels 512 and 126, or the rear wheels 1012 and 1022, do not need to be at the same orientation for the processing circuit 140 to control the traction motors to move the electric vehicle 500 along the course indicated by the steering wheel 130. In the steering system 1070, the processing circuit 140 may detect the orientation of all wheels, 512, 126, 1012 and 1022, and independently control the traction motors DSF, PSF, DSR and PSR respectively to move the electric vehicle 500 along the path indicated by the steering wheel 130.

In another embodiment, the processing circuit 140 does not use wheel orientation information from the wheel orientation sensors 192 or the orientation controllers 1040-1046 to determine the orientation of the wheels. In this embodiment, the processing circuit 140 receives information from the turning radius detector 1030. The turning radius detector 1030 includes sensors (e.g., speed sensors, acceleration sensors, gyroscopes) configured to detect the turning radius of the electric vehicle 500. The processing circuit 140 may compare the detected turning radius to the turning radius as indicated by the steering wheel 130. If the difference between the detected turning radius and the desired turning radius is greater than the error threshold, the processing circuit 140 may control the traction motors until the detected turning radius matches the desired turning radius to within the tracking threshold.

In another example embodiment, the wheel orientation information from the wheel orientation sensors 192 or the orientation controllers 1040-1046 is supplemented by the information from the turning radius detector 1030.

### Stored Data

The information shown in FIGS. 2 and 4 may be used to correlate the rotation of the steering wheel 130 to the orientation of the wheels 512 and 126 for the electric vehicle 500 to travel the path indicated by the steering wheel 130. For example, if the steering wheel 130 is positioned at max CCW position 240 then the wheels 512 and 126 would need to be oriented at max leftward orientation 440 for the electric vehicle 500 to travel the path indicated by the steering wheel 130. As discussed above, the data of FIG. 2 and/or FIG. 4 correlate to the information of FIG. 8. The data in FIG. 2 may be correlated to the data in FIG. 8 to determine a turning radius of the electric vehicle 500 for a particular position of the steering wheel 130. The data in FIG. 4 may be correlated to the data in FIG. 8 to determine the turning radius of the electric vehicle 500 for a particular orientation of the wheels 512 and 126.

For example, the max CW rotation of the steering wheel 130 correlates to the min right radius 830, which indicates that the driver wishes the electric vehicle 500 to travel a path indicated by line 920 with the minimum radius 930. The max rightward orientation of the wheels 512 and 126 correlates to the min right radius 830, which will result in the electric vehicle 500 traveling the path having path indicated by line 920 with the minimum radius 930.

The data needed to correlate the orientation (e.g., position) of the steering wheel 130 to the desired turning radius and/or the orientation of the wheels 512 and 126 to the wheel turning radius and/or the position of the rack 110 to the wheel turning radius may be stored for use by the processing circuit 140 to performance its functions. The data may be stored as graphs similar to the data shown in FIGS. 2-4 and 8. The data may be stored in tables, equations or any other format for use by the processing circuit 140. The data may be stored in the memory 142.

### In Operation

An example of combining skid steering with the current state of the malfunctioning steering system 100 or 1070 is shown in FIG. 11. In FIG. 11, the steering wheel is rotated in the clockwise direction and is being held by the driver at the point 214 as shown in in FIG. 2. If the steering system 100 or 1070 were functioning properly, the electric vehicle 500 would steer along the path and turning radius 914 as shown in FIG. 9. However, because of some malfunction in the steering system 100 or 1070, the wheels 512 and 126 are positioned in the rightward orientation at the point 212. The driver has turned the steering wheel 130 to the point 214, but the wheels 1010 and 1020 have turned only to the orientation at the point 212. So, the electric vehicle 500, instead of turning along the path having the turning radius 914, it turns along the path having the turning radius 912.

The processing circuit 140 detects the rotation of the steering wheel 130 and determines that the steering wheel 130 has been rotated to the point 214. Further the processing circuit 140 detects the position of the rack 110, via the rack sensor 180, and/or the orientation of the wheels 512 and 126 via the wheel orientation sensors 190 or orientation controllers 1040 and 1042. The processing circuit 140 determines that there is a discrepancy between the direction indicated by the driver (e.g., desired turning radius) and the direction set by the orientation of the wheels 512 and 126 (e.g., wheel turning radius). The processing circuit 140 is configured to determine how to control the traction motors DSF, PSF, DSR and/or PSR so that the electric vehicle 500 travels along the path indicated by the turning radius 914, as indicated by the steering wheel 130, instead of traveling along the path indicated by the turning radius 912, as determined by the orientation of wheels 512 and 126. As discussed above, to overcome the discrepancy, the processing circuit 140 increases the rate of rotation 1110 and 1112 of wheels 512 and 1012 to be greater than the rate of rotation 1120 and 1122 of wheels 126 and 1022. The difference in the rates of rotation causes the electric vehicle 500 to skid turn to travel along the path indicated by the turning radius 914 as opposed to the path indicated by the turning radius 912.

The difference in the speed of rotation of wheels 512 and 1012 and wheels 126 and 1022 may be created by causing traction motor DSF and traction motor DSR to rotate at a higher rate than the traction motor PSF and the traction motor PSR. While performing skid steering, the processing circuit 140 may further attempt to move the electric vehicle 500 at the speed indicated by the throttle. The processing circuit 140 may detect the forward or reverse speed of the electric vehicle 500 to maintain the forward or reverse speed consistent with the speed indicated by the throttle even while altering the rate of rotation of the wheels to accomplish the skid steering.

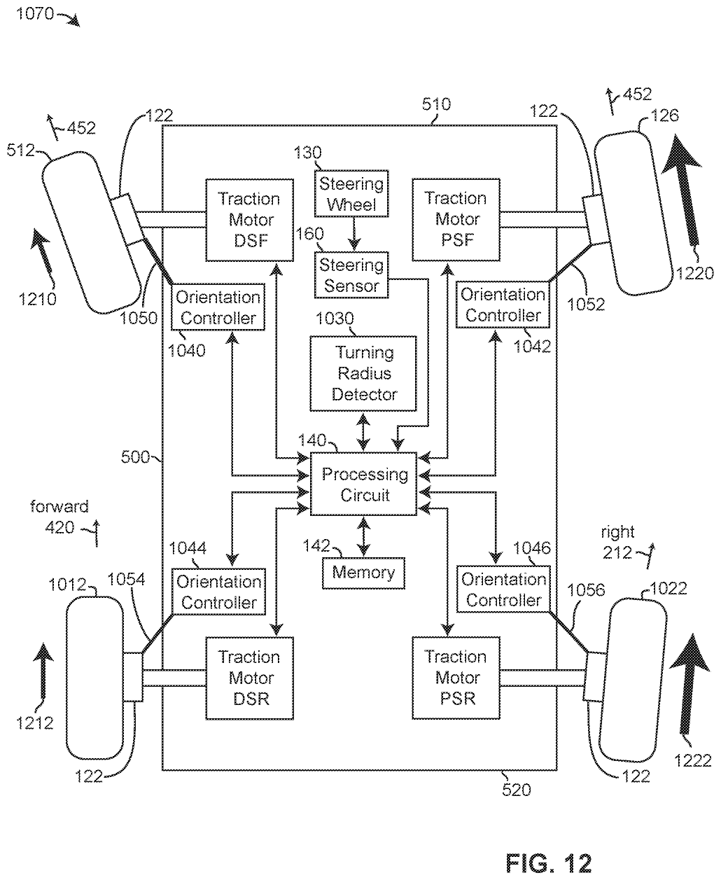

In another example, shown in FIG. 12, the steering wheel 130 is rotated to max CCW position 240, so the electric vehicle 500 should travel along the path indicated by line 920 but in the leftward direction with a turning radius of 930. However, in this example, due to a failure of the steering system 1070, the wheel 512 is oriented at leftward 414, referring to FIG. 4, and the wheel 126 is oriented at leftward 412 when they both should be oriented at max leftward orientation 440. Further, the wheel 1012 is oriented at forward 420 while wheel 1022 is oriented at rightward direction 212.

The processing circuit 140 detects the orientations of the wheels 512, 126, 1012 and 1022, and determines the desired direction and turning radius as indicated by the steering wheel. The processing circuit 140 is configured to determine the rate and direction of rotation for each wheel 512, 126, 1012 and 1022 so that the electric vehicle 500 will travel in the direction with the desired turning radius indicated by steering wheel 130. The processing circuit 140 is further configured to attempt to maintain the speed indicated by the throttle while compensating for steering system failure.

In this case, the processing circuit sets rate and/or direction of rotation 1210, 1220, 1212, and 1222 for the wheels 512, 126, 1012 and 1022 respectively. In this example, the direction of rotation 1212 may be in the reverse direction to help overcome the orientation of wheel 1022 which is opposite the desired direction of travel. The processing circuit 140 may control the traction motor PSF so that the rate of rotation 1220 is greater than the rates of rotation of traction motors DSS and DSR and thereby the rates of rotation 1210 and 1212. The rate of rotation 1220 is sufficiently greater than the rate of rotation of 1210 and/or 1212 to skid steer the electric vehicle 500 along the path indicated by line 920 in the leftward direction with a steering radius of 930.

The rate of rotation 1222 of wheel 1022 may be problematic. The wheel 1022 has a rightward orientation whereas the steering wheel 130 indicates a leftward direction of travel and turning radius. In this case, the rate of rotation 1222 may need to be greater than the rate of rotation 1220 to keep the electric vehicle 500 moving in the direction indicated by the steering wheel 130. It is also possible that the traction motor PSR may be put in neutral so that rotation of the wheel 1022 does not pull the electric vehicle 500 in the rightward direction. The wheel 1022 may freely turn as it is pulled by the rotation of wheels 512, 126 and 1012. In another case, traction motors DSR and PSR may both be placed in neutral so that wheels 512 and 126 control the speed and direction of travel of the electric vehicle 500. A wheel that is been placed in neutral may be dragged by the other wheels in the desired direction.

Skid steering may be used to supplement the steering that is provided by the steering system 100 or 1070 when operating properly. Skid steering may be used to supplement the steering system 100 or 1070 to compensate for the effects of terrain (e.g., snow, ice, sand, gravel) on one or more of the wheels 512, 126, 1012 and 1022. Skid steering may be used to supplement steering whether the direction of steering is in the forward, rightward or leftward direction and/or whether the direction of travel is forwards or backwards.

In another embodiment, the processing circuit 140 is configured to provide a warning to the driver upon detecting the failure of the steering system 100 or 1070. After providing the warning, if the driver does not deaccelerate within a period of time, the processing circuit 140 may be configured to slow the velocity of the electric vehicle 500. The period of time allowed for the driver to slow down may correlate to the speed of the electric vehicle 500. In one implementation, the higher the speed of the vehicle, the shorter the period of allowed time to begin slowing. In another example embodiment, the period of time is longer for higher speeds. The rate at which the processing circuit 140 slows the vehicle may also depend on the speed of the electric vehicle. The faster the electric vehicle 500 is traveling, the more gradual the rate of slowing. The processing circuit is configured to slow the electric vehicle 500 until it is traveling at a maximum speed for safe operation without the steering system, or another words, by skid steering alone. Slowing the vehicle may provide increased stability of the electric vehicle 500 as the processing circuit 140 controls the traction motors to perform skid steering to overcome the defects of the steering systems 100 or 1070 to steer the vehicle.

### AFTERWORD

The foregoing description discusses embodiments (e.g., implementations), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A system for steering an electric vehicle comprising:
a steering sensor configured to provide a first data regarding a first orientation of a steering wheel;
two front wheels;
two front traction motors, each front traction motor configured to control a rate and a direction of rotation of one front wheel respectively in accordance with a second data;
two front orientation controllers, each front orientation controller configured to detect a second orientation of one front wheel respectively, each front orientation controller configured to provide a third data regarding the second orientation of its respective front wheel;
a processing circuit; wherein:
the processing circuit is configured to:
determine a desired turning radius of the electric vehicle in accordance with the first data;
determine in accordance with the third data whether the electric vehicle will move along a path indicated by the desired turning radius;
responsive to determining that the electric vehicle will not move along the path indicated by the desired turning radius, the processing circuit is configured to:
determine the second data to control the rate and direction of rotation of each front wheel so that the rate and direction of rotation of the two front wheels causes, regardless of the second orientation of the two front wheels, the electric vehicle to move along the path of the desired turning radius; and
provide the second data to the two front traction motors.

2. The system of claim 1 wherein the rotation of the front wheels in accordance with the second data causes the electric vehicle to move along the path indicated by the desired turning radius to within a tracking threshold.

3. The system of claim 1 wherein to determine in accordance with the third data whether the electric vehicle will move along the path indicated by the desired turning radius, the processing circuit:
determines a wheel turning radius in accordance with the second orientation of the two front wheels as indicated by the third data; and
compares the desired turning radius to the wheel turning radius.

4. The system of claim 3 wherein to determine that the electric vehicle will not move along the path indicated by the desired turning radius, the processing circuit determines that the desired turning radius differs from the wheel turning radius by more than an error threshold.

5. The system of claim 3 wherein to determine the wheel turning radius, the processing circuit accesses stored data that relates the second orientation of the two front wheels, as described by the third data, to the wheel turning radius.

6. The system of claim 1 wherein to determine the desired turning radius, the processing circuit accesses stored data that relates the first orientation of the steering wheel, as described by the first data, to the desired turning radius.

7. The system of claim 1 wherein:
each front orientation controller further controls the second orientation of one front wheel respectively in accordance a fourth data;
the processing circuit determines the fourth data in accordance with the first data; and
each front orientation controller, when operating properly, orients its respective front wheel in accordance with the fourth data so that the electric vehicle will move along the path indicated by the desired turning radius.

8. The system of claim 1 further comprising:
two rear wheels;
two rear traction motors, each rear traction motor configured to control a rate and a direction of rotation of one rear wheel respectively in accordance with the second data; and
two rear orientation controllers, each rear orientation controller configured to provide the third data regarding the second orientation of its respective rear wheel.

9. The system of claim 8 wherein to determine in accordance with the third data whether the electric vehicle will move along the path indicated by the desired turning radius, the processing circuit:
determines a wheel turning radius in accordance with the second orientation of the two front wheels and the two rear wheels as indicated by the third data; and
compares the desired turning radius to the wheel turning radius.

10. The system of claim 9 wherein responsive to determining that the electric vehicle will not move along the path indicated by the desired turning radius, the processing circuit is further configured to:
determine the second data to control the rate and direction of rotation of each front wheel and each rear wheel so that the rate and direction of rotation of the two front wheels and the two rear wheels regardless of the second orientation of the two front wheels and the two rear wheels causes the electric vehicle to move along the path indicated by the desired turning radius; and
provide the second data to the two front traction motors and the two rear traction motors.

11. The system of claim 9 wherein to determine the wheel turning radius, the processing circuit accesses stored data that relates the second orientation of the two front wheels and the two rear wheels, as described by a fourth data, to the wheel turning radius of the electric vehicle.

12. A system for steering an electric vehicle comprising:
a steering sensor configured to provide a first data regarding a first orientation of a steering wheel;
two front wheels;
two front traction motors, each traction motor configured to control a rate and a direction of rotation of one front wheel respectively in accordance with a second data;
a rack for orienting the two front wheels;
a pinion for positioning the rack to orient the front wheels in accordance with a third data;
two front orientation sensors, each front orientation sensor configured to detect a second orientation of one front wheel respectively, each front orientation sensor configured to provide a fourth data regarding the second orientation of its respective front wheel;
a processing circuit; wherein:
the processing circuit is configured to:
determine a desired turning radius of the electric vehicle in accordance with the first data;
determine in accordance with the fourth data whether the electric vehicle will move along a path indicated by the desired turning radius;
responsive to determining that the electric vehicle will not move along the path indicated by the desired turning radius, the processing circuit is configured to:
determine the second data to control the rate and direction of rotation of each front wheel so that the rate and direction of rotation of the two front wheels regardless of the second orientation of the two front wheels causes the electric vehicle to move along the path indicated by the desired turning radius; and
provide the second data to the two front traction motors.

13. The system of claim 12 wherein the rotation of the front wheels in accordance with the second data causes the electric vehicle to move along the path indicated by the desired turning radius to within a tracking threshold.

14. The system of claim 12 wherein to determine in accordance with the fourth data whether the electric vehicle will move along the path indicated by the desired turning radius, the processing circuit:
determines a wheel turning radius in accordance with the second orientation of the two front wheels as indicated by the fourth data; and
compares the desired turning radius to the wheel turning radius.

15. The system of claim 14 wherein to determine that the electric vehicle will not move along the path indicated by the desired turning radius, the processing circuit determines that the desired turning radius differs from the wheel turning radius by more than an error threshold.

16. The system of claim 12 wherein:
the processing circuit determines the fourth data in accordance with the first data; and
the rack and the pinion, when operating properly, orient the front wheels in accordance with the fourth data so that the electric vehicle will move along the path indicated by the desired turning radius.

17. The system of claim 12 further comprising:
two rear wheels;
two rear traction motors, each rear traction motor configured to control a rate and a direction of rotation of one rear wheel respectively in accordance with the second data; and
two rear orientation controllers, each rear orientation controller configured to provide the fourth data regarding the second orientation of its respective rear wheel.

18. The system of claim 17 wherein responsive to determining that the electric vehicle will not move along the path indicated by the desired turning radius, the processing circuit is further configured to:
determine the second data to control the rate and direction of rotation of each front wheel and each rear wheel so that the rotation of the two front wheels and the two rear wheels regardless of the second orientation of the two front wheels and the two rear wheels causes the electric vehicle to move along the path indicated by the desired turning radius; and
provide the second data to the two front traction motors and the two rear traction motors.
